(19) United States
(12) Patent Application Publication
(10) Pub. No.: US 2002/0033668 A1
(43) Pub. Date: Mar. 21, 2002

(54) Method for thoroughly eliminating electrophoresis effects of DC fluorescent lamp tube

(76) Inventor: Yu Xihu, Qingdao City (CN)

Correspondence Address: Xiaoping Li, 900 Glen Rock Drive, Westerville, OH, 43081, US

(21) Appl. No.: 09/921,042

(22) Filed: Aug. 2, 2001

(30) Foreign Application Priority Data
Aug. 8, 2000 (CN) 00 1 11273.2

(51) Int. Cl. H01J 17/20; H01J 61/12

(52) U.S. Cl. 313/570

(57) ABSTRACT

A method applicable in the field of electric light source technology for thoroughly eliminating “Electrophoresis effects” of a DC fluorescent lamp tube is used for the DC fluorescent lamp. It is characterized by that this method involves changing the relative positions and structures of the cathode and anode of the lamp tube solely and/or simultaneously, coating a euphotic infrared film on either inside or outside wall at the cathode end of the lamp tube, placing mercury-absorbed material into the vent-pipe at the anode end, assembling a heat-preservation sealed encloser with high transparency under the lampshade and charging krypton gas and xenon gas accounting for 20-60% of the total volume of inert gases with volumeter. The method can thoroughly eliminate “Electrophoresis effects” of DC fluorescent lamp tube and has solved the extremely difficult problem in the world, and prolonged the working life of the lamp tube, with the advantages of simple structure and low cost.

This invention disclose a method applicable in the field of electric light source technology for thoroughly eliminating “Electrophoresis effects” of DC fluorescent lamp tube, which is mainly applicable to the DC fluorescent lamp.

In order to solve the harm of stroboscopic problem and high-frequency electro magnetic radiation of a AC fluorescent lamp, an energy-saving DC fluorescent lamp tube in series without stroboscopic problem and electro magnetic radiation has been developed mainly by this applicant in the existing technologies, for which the patent has been applied for and obtained in our country. One of the biggest problems in the world faced by the DC fluorescent lamp is that “Electrophoresis effects” is produced when DC current flows in the fluorescent lamp tube. (That is, when DC current flows in the lamp tube, mercury ions will move from anode to cathode, which makes the end of anode turn dim because of lack of mercury ions activating fluorescent materials to radiate). Especially, when larger current flows in a DC fluorescent lamp tube with long length and high voltage, “Electrophoresis effects” may produce in a few hours or even scores of minutes. To solve this problem, a high-efficiency energy-saving DC fluorescent lamp was invented mainly by this applicant, which was granted patent No. 95110328.8. The lamp adopts the method of exchanging the polarity of the lamp tube to eliminate the “Electrophoresis effects”, which ensures that no “Electrophoresis effects” can be produced within 80-100 hours. But the disadvantage is that when the lamp is turned on each time, the polarity of the anode and cathode must be exchanged once by a polarity switching device. It is not only troublesome to operate but also difficult to use under certain cases. Taking the industrial illuminative DC fluorescent lamp with high assembling height to ground and large power of 40W as an example, for making four contacts switched at the same time, the structure of the electric circuit is bound to be complicated and the reliability is poor and the cost is heavy.

The object of this invention is to provide a method which can not only thoroughly eliminate the “Electrophoresis effects” produced when DC current flows in a DC fluorescent lamp tube by improving the structure of the DC fluorescent lamp tube and its accessories (including categories, proportions and total pressure of charged inert gases in the tube), but also can prolong the service life of the lamp tube, what is more, it features simple structure, low cost and convenient installation and use.

In accordance with the motion law of mercury ions and atoms in the DC discharging field and the mechanism of “Electrophoresis effects” of mercury ions and for tackling the major problems in existing technologies, especially patent technology of this applicant's patent No. 95110328.8, the primary conceive of this invention includes making a substantial improvement on the basis of patent technology for a DC fluorescent lamp tube and its accessories as described in patent No. 95110328.8. That is to say, to change the motion law of mercury ions and atoms by adjusting the relative positions and structures of the anode and cathode in the DC fluorescent lamp tube at the ends of the lamp tube, i.e., to set the cold point of the DC fluorescent lamp tube at the bottom of the lamp tube behind the anode. Thus, when superfluous mercury exists, mercury will congregate (coagulate) here, the existence of mercury atoms at the end of anode can be guaranteed permanently; while the filament at the end of cathode should be near to the bottom of the lamp tube as possible, so that the congregation of superfluous mercury at the heating zone of cathode can be prevented. As an improvement, the cathode adopts a three-spiral filament in shape of short stem (or flat stem) and is added with an L-shape metal protection ring; while the anode adopts a filament shape with volume (power) larger than that of the cathode as well as without coating electronic powder or adopts either shape, flat or circular, with the reception area as large as possible. Thus, both the potential drop and temperature of the anode can be decreased. In order to keep the temperature at the cathode end of cathode of the DC fluorescent lamp tube higher than that at the end of anode, a euphotic layer of infrared reflective film (heat-preservation layer) can be coated on either inside or outside wall at the end of the cathode of the lamp tube, so that the heat produced on filament at the end of cathode can be prevented from diffusing quickly, the temperature at the end of a fluorescent lamp tube can be higher than that at the end of anode from the beginning to the end, and a certain range of temperature can be maintained. At the same time, enough mercury-absorbed material such as indium can be placed in a suitable position behind anode at the anode end of the DC fluorescent lamp tube, for example, in the vent-pipe at the anode end or at the position near to the place where the wire of anode is close to anode. When the temperature rises slowly while the lamp tube is working, mercury absorbed in the material can be gradually released to compensate the deficiency of mercury at the anode end. When the lamp tube stops working, the mercury gas in the lamp tube can be again absorbed by the mercury-absorbing material following the decrease of the temperature of the lamp tube. This can not only eliminate the “Electrophoresis effects”, but also make the lamp tube start up easily. Additionally, a heat-preservation sealed encloser with a high degree of transparency can be assembled under the lampshade of the DC fluorescent lamp tube, so that the entire DC fluorescent lamp tube can work in a closed environment with higher temperature; or the categories proportions and general intensity of pressure of charged inert gases in the DC fluorescent lamp tube can be changed, that is to say, to charge inert gases, krypton or xenon with small mobility to mercury ions accounting for 20-60% of the total volume of inert gasses with volumeter, into charged inert gas argon under the conditions permitted by other photoelectric parameters, so that the intention of the invention can be realized.

The method of thoroughly eliminating “Electrophoresis effects” of DC fluorescent lamp tube as described in this invention is characterized by solely and/or simultaneously changing, as follows, the structures of the lamp tube and its accessories in accordance with the length and diameter of the lamp tube, the magnitude of the electric current flowing in the lamp tube, and power:

(1) Changing the relative positions of the anode and cathode of the DC fluorescent lamp tube at both ends of the lamp tube and the structures of the anode and cathode so as to set the cold point of DC fluorescent lamp tube at the bottom of the lamp tube behind the anode. That is to say, to make the distance between the filament at the cathode end and the bottom of the lamp tube shorter than that between the anode and the bottom of the lamp tube, so that the superfluous mercury can not congregate (coagulate) at the bottom of the cathode but can do at the bottom of the lamp tube at the anode end.

(2) Coating a euphotic layer of infrared reflective film at either inside or outside wall at the cathode position at the cathode end of a DC fluorescent lamp tube.

(3) Placing mercury-absorbed material inside the vent-pipe at the anode end and/or at the position near to the place where the wire of anode is close to anode.

(4) Assembling additionally a heat-preservation sealed encloser with a high degree of transparency under the lampshade of a DC fluorescent lamp tube.

(5) Under the permission by other photoelectric parameters, charging inert gases, krypton and/or xenon with small mobility to mercury ions which accounts for 20-60% of the total volume of inert gasses with volume, into the lamp tube and keeping the general pressure at 300-800 Pa.

Aforementioned (1) Changing the structures of the cathode and anode of a DC fluorescent lamp tube refers to the change of the cathode into three-spiral filament in shape of short stem or flat stem, and adding an L-shape or oval metal protection ring, while changing the anode into a filament shape with volume (power) larger than that of the cathode and without coating electronic powder or changing into any kind of shape in flat or circular shape with the reception area as large as possible.

Aforementioned (4) Assembling additionally a heat-preservation sealed encloser with a high degree of transparency under the lamp shade of a DC fluorescent lamp tube can only be co-used with the aforementioned (3) Placing mercury-absorbed materials into the vent-pipe at the anode end and/or at the position near to the place where the wire of anode is close to anode and (5) Under the permission by other photoelectric parameters, charging inert gases krypton and/or xenon accounting for 20-60% of the total volume of inert gasses with volumeter into the lamp tube, they can not be co-used with the aforementioned (1) Changing the relative positions of the anode and cathode of the DC fluorescent lamp tube at both ends of the lamp tube and the structures of the anode and cathode, and (2) Coating a euphotic layer of infrared reflective film at either inside or outside wall at the cathode position at the cathode end of a DC fluorescent lamp tube.

The outstanding advantage of this invention is that it can not only thoroughly eliminate the “Electrophoresis effects” of a DC fluorescent lamp tube by improving the structure of the DC fluorescent lamp tube and its accessories so that the international difficult technical problem is solved and it is helpful to further promotion and application of the DC fluorescent lamp, but also prolong the service life of the lamp tube, what's more, it features the simple improved circuit structure and low cost. It is convenient to assemble and use and easy to start up the device.

One of the preferred embodiment of this invention is: a 40 W DC fluorescent lamp tube can substitute a common 40 W AC fluorescent lamp tube, can be energized by either 220 V or 110 V AC power supply and ignited by DC voltage output undergone commutating and filtering. The length of the lamp tube is exactly the same with that of a common 40 W AC fluorescent lamp tube and conforms to the regulation for length in the state standard GB 10682-89, the diameter of the lamp tube is Φ 38 mm for T₁₂, (you can also take options of Φ32 mm for T₁₀ and Φ26 mm for T₈). That is, L/Φ>15, and a long lamp tube type is available with larger DC voltage drop (90 V-140 V) (but the change range of voltage drop of a DC fluorescent lamp tube for each specification is small) and the current flowing the lamp tube is more than 300 mA. In order to thoroughly eliminate the produced by high power and large current in such kind of long lamp tube, a three-spiral filament is selected as the cathode filament, and an L-shape metal protection ring is added. The anode adopts a flat shape, with the reception area for electronics as large as possible. This can not only decrease potential drop of anode, but also lower the temperature of the anode. The distance between cathode (filament) and bottom of the lamp tube is shorter than that between the anode and the bottom of the lamp tube. A heat reflective screen is set between the anode and the bottom of the lamp tube, that is to say, the cold point of the lamp tube is set at the bottom of the lamp tube at the anode end, so that the superfluous mercury in the lamp tube can coagulate at the bottom of the lamp tube at the anode end with lowest temperature, ensuring the existence of mercury from the beginning to the end at the anode end, so that no “Electrophoresis effects” can be produced. Meanwhile, some indium threads can be put into the vent-pipe at anode end and a euphotic layer of infrared reflective film can be coated on the outside wall of the lamp tube, near to the filament at the bottom of the cathode end of the lamp tube. For T₈ type thin lamp tube with voltage drop of above 100 V, krypton gas accounting for 50% of total volume of inert gases can be charged additionally when the lamp tube is processed and discharged. The general pressure should conform to the requirement for pressure drop of a DC lamp tube, to be about 400 Pa.

The second one of the preferred embodiment of this invention is: a compacted 2D type long lamp tube with power of 16-28 W which can be ignited directly by 220 V or 110 V DC voltage, with the length of lamp tube L=50 cm˜90 cm and diameter of the lamp tube Φ=1.4 cm˜2 cm, L/Φ>15. The voltage drop of the DC lamp tube is 90˜130 V (but the change range of voltage drop for DC lamp tube of each specification is small, at about ±5 V). The DC current flowing in the lamp tube is 140˜300 mA. The cathode adopts a three-spiral filament with strong power and low resistance, is added with an L-shape metal protection ring, and the distance between the cathode and the bottom of the lamp tube is shorter. The anode adopts the filament with volume (power) larger than that of cathode and without coating electronic powder. The distance between anode and the bottom of the lamp tube is longer. Mercury-absorbed material in granule shape, indium is put into the vent-pipe at the anode end, Xenon gas accounting for 40% of the general volume of inert gases is additionally charged with volumeter, the total pressure shall conform to the requirement for pressure drop of the lamp tube, to be about 500 Pa.

The third one of the preferred embodiment of this invention is: a compacted single U-type long lamp tube with power of 9 W-16 W, which can be ignited directly by DC voltage undergone commutating and filtering, and energized by 220 V or 110 V AC power supply, with the length of a lamp tube L=40 cm˜50 cm and diameter of the lamp tube Φ=1.0 cm˜1.4 cm, L/Φ>15. The voltage drop of the DC lamp tube is 80˜120 V. The DC current flowing in the lamp tube is 100˜160 mA. The cathode adopts a three-spiral filament. The anode adopts the filament with volume (power) larger than that of cathode and without coating electronic powder. The distance between anode and the bottom of the lamp tube is equal to that between the cathode and the bottom of the lamp tube. Mercury-absorbed material in granule shape, indium is put into the vent-pipe at the anode end. A heat preservation sealed encloser made of material with high transparency is assembled under the lampshade. Krypton gas can be charged additionally when Argon is charged.

### Amendments Applicable to this Embodiment

1. For each embodiment instance, the shape of the protection ring added to cathode filament can be in either L or oval shape; while the anode can be in filament shape with volume (power) larger than that of cathode, or in either flat or circular shape, with the reception area as large as possible;

2. For each embodiment instance, if one change made in structure or position can eliminate the “Electrophoresis effects” of the lamp tube thoroughly, it will be unnecessary to use other structures or positions;

3. For each embodiment instance, the additionally charged krypton or xenon gases can be exchanged, or be substituted by mixed gases of krypton and xenon in equal proportion, which shall account for 20-60% of the general volume of the gases by means of volumeter.

4. In the second embodiment instance, the lamp tube can be of single U or double U type.

5. In the third embodiment instance, the lamp tube can be of H type.

6. For the first embodiment instance, the lamp tube can be applied to 30 W, 60 W etc. besides 40 W.

7. For each embodiment instance, the short stem or flat stem of the cathode can be exchanged. The additionally-added metal protection ring in L-shape can be exchanged for that in oval shape, and the anode in filament shape can be exchanged for the anode in flat or circular shape.

1. A method of thoroughly eliminating “Electrophoresis effects” of DC fluorescent lamp tube is characterized by solely and/or simultaneously changing the following structures of the lamp tube and its accessories in accordance with the length and diameter of the lamp tube, the magnitude of the current flowing in the lamp tube, and power: (1) Changing the relative positions of the anode and cathode of a DC fluorescent lamp tube at both ends of the lamp tube and the structures of the anode and cathode, that is, to make the distance between the filament at the cathode end and the bottom of the lamp tube shorter than that between the anode and the bottom of the lamp tube; (2) Coating a euphotic layer of infrared reflective film at either inside or outside wall at the cathode position at the cathode end of a DC fluorescent lamp tube; (3) Placing mercury-absorbed material into the vent-pipe at the anode end and/or at the position near to the place where the wire of anode is close to anode; (4) Assembling additionally a heat-preservation sealed encloser with a high degree of transparency under the lampshade of a DC fluorescent lamp tube; (5) Charging inert gases of krypton and/or xenon in accordance with their volume accounting for 20-60% of the total volume of inert gasses into the lamp tube and keeping the total pressure within 300-800Pa.

2. The method of thoroughly eliminating the “electrophoresis effects” of DC fluorescent lamp tube as described in claim 1 above is characterized by the aforementioned (1) Changing the structure of the cathode or anode of a DC fluorescent lamp tube refers to the change of the cathode into a three-spiral filament in short stem shape with an L-shape metal protection ring; while the anode can be changed into filament shape without coating electronic powder with the volume larger than that of cathode;

3. The method of thoroughly eliminating the “electrophoresis effects” of a DC fluorescent lamp tube as described in claim 1 above is characterized by the aforementioned (1) Changing the structure of the cathode or anode of a DC fluorescent lamp tube refers to further change of the cathode into a three-spiral filament in a flat stem shape with an oval shape metal protection ring; while the anode can also be changed into either shape, flat or circular, with a larger reception area.

4. The method of thoroughly eliminating the “electrophoresis effects” of DC fluorescent lamp tube as described in claim 1 above is characterized by the aforementioned (4) Assembling additionally a heat-preservation sealed encloser with a high degree of transparency under the lampshade of a DC fluorescent lamp tube, only to be co-used with the aforementioned (3) Placing mercury-absorbed material into the vent-pipe at the anode end and/ or at the position near to the place where the wire of anode is close to anode and (5) According to the charging of inert gases of krypton and/or xenon in accordance with their volume accounting for 20-60% of the total volume of inert gases into the lamp tube.
